(19) United States
(12) Patent Application Publication
(10) Pub. No.: US 2009/0168991 A1
(43) Pub. Date: Jul. 2, 2009

(54) Method and System for Dynamic Tracking and Assignment of Agent Resources within a Contact Center

(76) Inventors: Stanislav Zgardovski, Concord, CA (US); Oleksiy Kolomoyskyy, Moraga, CA (US); Vladimir Pimtchenkov, Pleasant Hill, CA (US)

Correspondence Address: CENTRAL COAST PATENT AGENCY, INC, 3 HANGAR WAY SUITE D, WATSONVILLE, CA, 95076, US

(21) Appl. No.: 11/965,617

(22) Filed: Dec. 27, 2007

(51) Int. Cl. H04M 3/00

(52) U.S. Cl. 379/266.07

(57) ABSTRACT

A system for telephone campaigns includes a contact server for placing outbound contacts, a contact router for routing answered outbound contacts to available agents, and a statistical server for monitoring and serving current agent statistics ahead of each outbound contact or set of contacts initiated on behalf of two or more campaigns. The system is characterized in that the contact server initiates outbound contacts for the campaigns based on availability of agents assigned to the campaigns, and wherein agents assigned to more than one campaign are dynamically designated to serve only the outbound campaign associated with each contact at the time of contact initiation if determined available for the that campaign at the time of contact initiation, and a campaign group identifier is attached as contact data to each contact initiated.

### BACKGROUND OF THE INVENTION

1. Field of the Invention

The present invention is in the field of telephony communications including Internet Protocol telephony and pertains particularly to methods and a system for tracking and dynamically assigning agent resources within a contact center.

2. Discussion of the State of the Art

Managing agent resources in a contact center is a challenging prospect especially when many contact center activities are automated such as outbound contact campaigns. In an outbound contact campaign also referred to as “outbound contact campaign”, a contact server that has automated dialing capability is utilized to initiate outbound telephone calls or other contacts (such as emails, instant messages, videos and the like), and to monitor the states of agent groups, queues and individual agents state in order to be able to make intelligent predictions about when to initiate outbound contacts, and in order to make effective routing decisions once contacts have been successfully initiated.

Managing resources during the campaign is very critical. A service objective during the campaign is to make sure that all contacts initiated and answered during the campaign can be swiftly routed to an available agent who is qualified to handle the contact. In some cases, regulatory concerns dictate the service level, and the cost of not achieving it can be considerable. Therefore, the campaign typically initiates only a limited number of contacts, based on the number of available agents at some interval of contact initiation during the campaign. This number can be based on the actual number of available agents, or on a predicted number of agents that will be available at some time in the near future, depending on the mode of the server during the campaign.

A challenge with such an outbound contact connect and routing situation is the prospect of determining agent availability in part to determine how many contacts are to be initiated by the outbound server. The prospect of ensuring agent availability becomes more challenging when more than one campaign is being conducted and various agents also must conduct other contact center activities such as answering email, handling normal inbound traffic and so on.

The inventor is aware of a system for managing agent resources during an outbound campaign that relies on the agent's log-in identifier to determine if the agent is available or not available to take an outbound contact. In this system the outbound contact server also has to monitor the states of agent queues and agent availability by destination number (DN). Agents are grouped into virtual agent groups (VAGs) assigned as campaign routing targets.

One problem with the system is that an agent that is pre-configured to work in more than one VAG may be counted as available to receive contacts for two or more campaigns simultaneously. In this regard, the agent availability state may result in the outbound contact server initiating too many contacts. This can result in answered contacts being abandoned because of incorrect agent availability determination at the time of contact initiation.

What is needed is a system and methods for monitoring availability and switching agent availability determination or outbound campaign assignments of available agents to better manage outbound contact initiation and routing. A system such as this will provide better event connection to agents and reduce the number of contacts that go abandoned.

### SUMMARY OF THE INVENTION

In an embodiment of the invention a system for campaigns is provided, comprising a contact server for placing outbound contacts, a contact router for routing answered outbound contacts to available agents, and a statistical server for monitoring and serving current agent statistics ahead of each outbound contact or set of contacts initiated on behalf of two or more campaigns. The system is characterized in that the contact server initiates outbound contacts for the campaigns based on availability of agents assigned to the campaigns, and wherein agents assigned to more than one campaign are dynamically designated to serve only the outbound campaign associated with each contact at the time of contact initiation if determined available for the that campaign at the time of contact initiation, and a campaign group identifier is attached as contact data to each contact initiated.

Also in an embodiment a contact server for placing outbound contacts is provided, comprising an automated dialer, an interface to a stat server, a processor for processing statistics, and a data port connected to a router. The server is characterized in that the contact server receives from the stat server information regarding agent availability and agent campaign assignment, processes the information against one or more rules, associates each available agent with one and only one campaign at the time of contact initiation, and attaches an agent group identifier as data to each outbound contact, the identifier serving to route answered contacts to available agents.

In another aspect a method for conducting an outbound telephone campaign is provided, comprising the steps of (a) determining agent availability at the time of contact initiation; (b) considering each available agent as assigned to one and only one campaign at the time of contact initiation, regardless of pre-assignment; (c) appending a campaign group identifier to each outbound contact; and (d) using the identifier from step (c) to route answered contacts to available agents.

### BRIEF DESCRIPTION OF THE DRAWING FIGURES

FIG. 1 is a block diagram illustrating agent resource monitoring and internal routing of answered outbound contacts according to an embodiment of the present invention.

FIG. 2 is a block diagram illustrating an outbound contact server according to an embodiment of the present invention.

FIG. 3 is a block diagram illustrating contact abandonment resulting from no dynamic assignment capability.

FIG. 4 is a block diagram illustrating contact completion based on the ability to dynamically re-assign an available agent.

FIG. 5 is a process flow chart illustrating steps for determining contact initiation numbers during execution more than one outbound campaign according to an embodiment of the invention.

FIG. 6 is a block diagram illustrating contact completion based on universal agent assignment selection according to an embodiment of the present invention.

### DETAILED DESCRIPTION

In embodiments of the invention the inventor provides a system and methods for monitoring availability status of agent resources and leveraging those resources to complete answered contacts through dynamic assignment of resources during execution of one or more outbound contact campaigns within a contact center.

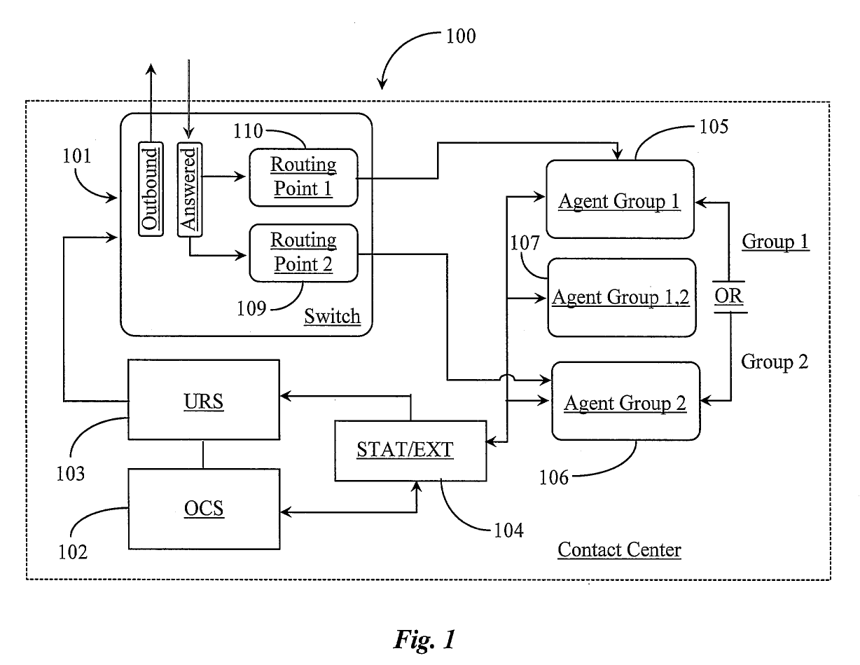

FIG. 1 is a block diagram illustrating agent resource monitoring and internal routing of answered outbound contacts according to an embodiment of the present invention. A contact center 100 is provided with the capability of running outbound contact campaigns. In this embodiment, center 100 includes a telephone switch 101, which may be a private branch exchange (PBX) or some other telephone switch capable of processing outbound contacts according to instruction. In one embodiment, switch 101 is an external switch and does not reside within the physical boundary of contact center 100. In another embodiment, switch 101 resides within the center and serves as a central telephone switching apparatus for internal routing in addition to facilitating execution of outbound contacts.

Contact center 100 includes an outbound contact server (OCS) 102 adapted, among other things, for placing outbound telephone contacts via an automated telephone dialing program (not illustrated) according to statistical information served about agent assignment and availability. OCS 102 uses statistics about agents to determine how many contacts will be initiated on behalf of an active outbound campaign.

Contact center 100 includes a number of contact center agents assigned in agent groups for working outbound campaigns. These groups comprise agents 105 in agent group 1, and agents 106 in agent group 2. Agent groups may be thought of as virtual agent groupings (VAGs) rather than physically assembled groups of agents. Typically agents discover their virtual group VG assignments when they log into the contact center system through their own workstations. Agents may include those physically present within the physical domain of the contact center and remote agents that may be logged into the system but are working from another physical location.

In this example, agents 105 are pre-assigned as a group (VG) to work a specific outbound contact campaign executed by OCS 102. Agents 106 are pre-assigned as a group to work another outbound campaign, which may, in some embodiment, be executed by OCS 102 in concurrence with one already running. Likewise, the campaigns may not overlap, however running simultaneous campaigns best illustrates and explains the monitoring and dynamic re-assignment of agent resources relative to more than one active campaign.

VG 1 and VG 2 each may have member agents pre-assigned to handle contacts for the other group as well as their own group. Agents 107 are pre-assigned in this example, to work contacts routed to either group VG1 or group VG2 as needed. All agent assignments and availability states are tracked and monitored by a statistics (STAT) server 104. STAT server 104 includes an adapter extension, which may be a Java Extension (SSJE) known to the inventor for providing universal recognition in the system metrics for agent/place objects, queue objects, routing point objects, and other contact center object models. Stat server 104 has access to all agent activity states as a group and as individuals and serves this information upon request or via subscription to stat server clients including OCS 102.

A universal routing server (URS) 103 is provided within contact center 100 and provides routing intelligence in cooperation with OCS 102 for use in determining outbound contact initiation, and for determining internal routing instructions for answered contacts (URS function). OCS 102 leverages stats from server 104 and executes its function through stat server 104 to URS 103, which has connection to switch 101 in this example. In this embodiment, OCS relies solely on stat server 104 to obtain the agent group and availability state of agents used for determining a number of contacts for outbound contact initiation based on the statistics for one or more than one active outbound campaign.

In this example, incoming routing strategy specifies that a routing point for internal routing of answered outbound contacts to agents is provided for each outbound campaign. In this example, logical routing point 110 (Routing Point 1) and logical routing point 109 (Routing Point 2) are illustrated and maintained within switch 101. It is not specifically required that routing points be maintained within switch 101 in order to practice the present invention. In one embodiment the routing points are maintained within URS 103 as configurable routing parameters in intelligence made available to switch 101 through the URS server intelligence in a CTI embodiment.

Routing point 1 (110) has agent group 1 (105) as a routing target. Routing point 2 (109) has agent group 2 (106) as a target. In a preferred embodiment, agent group 1 is pre-assigned to service one outbound contact campaign and agent group 2 is pre-assigned to service a second outbound contact campaign. Assuming two active outbound campaigns in progress, OCS 102 initiates contact, for example by dialing out, on behalf of both campaigns according to information received about agent groups 1 and 2 and the availability states of the agents within each group. Statistical information is continually updated as contacts are routed with agents becoming busy on contacts and agents being freed up to take a next contact and so on.

OCS 102 initiates contacts at intervals and contacts initiated on behalf of both campaigns are not necessarily segregated with respect to the time contacts are initiated. For example, as agents become available in either group, contacts may be initiated that target the group having the available agent or agents. Outbound contacts are illustrated from switch 101 and answered contacts are illustrated logically as coming in to switch 101. A certain percentage of contacts initiated will not be answered, and there may be a statistical average used to initiate dialing of more contacts than are indicated through agent availability statistics. The statistical value might be a value predicting the average number of contacts initiated that will not be answered. However, in a preferred embodiment, no abandoned contacts are acceptable in internal routing of answered contacts, so the number of contacts initiated may be held strictly equal to the number of agents determined available to take the contacts assuming all contacts are answered by customers.

In this example, all agents of groups 1 and 2 are pre-assigned a specific outbound campaign identifier for the agent, for example, an agent assigned to group 1 to campaign 1 and so on. Agents belonging to groups 1 and 2 may be pre-assigned to service both campaigns that target groups 1 and 2, specifically campaign 1 and campaign 2. There is a limitation imposed on availability statistics for any agent belonging to two virtual agent groups and therefore servicing two campaigns. That limitation is that the agent in question can only be determined available for one active campaign at a time. In this way, statistics do not report the agent available twice or more particularly, one availability determination for each campaign resulting in an extra contact being initiated that may go abandoned.

The constraint described above may be dynamically implemented for those agents having more than one campaign group assignment if they are determined available according to their current assignments and state. For example, when OCS 102 is planning execution of one or more contacts for the campaign groups, it determines the availability of agents and provides an accounting of a number of available agents in each of groups 1 and 2. Those numbers for each group=the number of outbound contacts initiated for each group. Therefore, if group 1 only has one available agent and group 2 has 2 available agents, than one contact is initiated on behalf of campaign 1 and two contacts are initiated on behalf of campaign 2, with a presumption that all three contacts will be answered and connected to appropriate agents. If the agent deemed available relative to group 1 also was assigned to group 2, a current assignment or “current campaign group ID number” is selected for the agent limiting that agent to servicing group 1 for that round of contacts.

The determination for designating a current campaign group identification number to an agent having more than one assignment can be based on contact distribution and contact completeness principles. Further, other rules may be consulted such as priority rules, time-based rules, and so on. For example, if one of the campaigns is completed before the other one, then one of the VGs is no longer needed for that campaign, and their assignments may be retracted. Likewise, those agents that are dually assigned may now be aggregated into the group that is still active by dynamic assignment update of “current campaign ID number” equal to the id number used by the still active campaign

The dually assigned agent may retain his or her virtual group assignment to the active group but may have the identifier of the campaign that was completed dropped as the identifier number or code may not be reusable. When the inactive group is assigned a new campaign, a new campaign ID number will be issued to the VG and agents in the group. Therefore, any dual assigned agent 107 may be shuffled dynamically into VG 1 or VG 2 depending on need at the time of outbound contact distribution.

OCS 102 has capability of attaching a campaign group identification number to an outbound contact as contact data at the time of contact initiation. Since the routing points are also uniquely designated, the contact when answered goes to the correct routing point. Further routing (agent level/queue level) depends on strategy in place. For example, if destination numbers are used for each agent, then that number may be part of the contact data attached to outbound contacts. If more than one queue is assigned to one agent group, then the queue destination number may be made part of the contact data as well.

It is noted that an agent may have a campaign group identification number and a VG assignment and be designated as not available because of some other priority within the contact center, such as answering some inbound traffic for example. In this case, the agent state may be considered in routing by presenting the statistic campaign group ID=0, meaning that the agent is currently not working any outbound campaigns and therefore the agent is not counted as available in the current round of contacts. However, the agent's status may be dynamically corrected should the situation warrant or through an overriding priority.

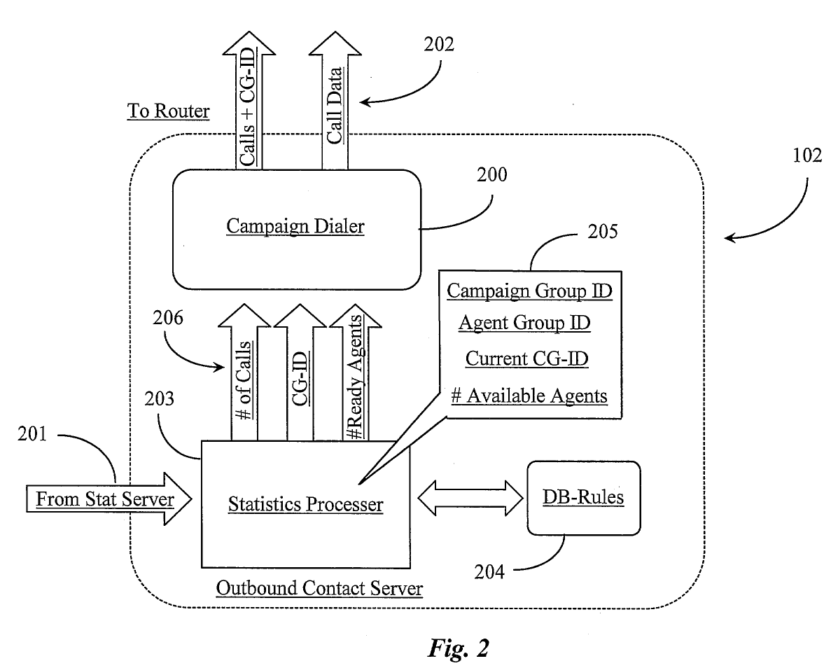

FIG. 2 is a block diagram illustrating outbound contact server 102 of FIG. 1 according to an embodiment of the present invention. OCS 102 includes a telephony dialing application or “campaign dialer” 200 for placing outbound contacts. OCS has data output 202 to a router such as URS 103 of FIG. 1 whereby the output includes initiated contacts with at least the campaign group identification number attached to each contact as attached contact data for routing purposes. Other contact data may also be communicated to the router that is not necessarily attached to each contact.

OCS 102 has statistics input 201 from a stat server such as stat server 104 of FIG. 1. OCS 102 includes a statistics processor 203 adapted to receive input 201 and process the statistics input against one or more rules 204, which may be served from a database. Processor 203 processes available statistics for parameters 205. OCS attaches campaign group ID for all outbound contacts. Agent group ID is determined from the statistics to identify the VGs servicing the campaigns. OCS 102 assigns any available agents having more than one campaign/VG assignment a current campaign group identifier based on accounting and weighting by rules. No agent may be considered at a point in time available to more than a single outbound campaign. The results of processing are the number of available agents for each active outbound campaign for which contacts will be initiated in the current round or interval of contact initiation. It is noted that contacts may be initiated as needed when agents are determined or “made” available for a campaign or contacts may be initiated periodically in contact sets.

The rules may be simple distributive rules that mitigate a case where an excess of agents are found available in one VAG but none available in another, causing one outbound campaign to stall. A priority rule may be in place, for example, to ensure that at least one contact goes out for each campaign at each contact initiation interval. Therefore, any of the agents available in the VG that are dually assigned may be shifted to service the VG currently showing no available agents. OCS 102 may designate a current campaign group ID (Current CG-ID) of the otherwise stalled campaign to one or more agents, making those agents temporarily available to service contacts for that one round. OCS may re-designate them back to their original group assignments as well by indicating another campaign group ID as the “current” ID for a next round of contacts.

Processor 203 provides statistics results indicating the number of agents ready to take contacts for a particular CG-ID, which is equivalent to the number of contacts initiated for that campaign by campaign dialer 200. More particularly, OCS 102 determines the number of contacts that will be initiated for each active outbound campaign.

A unique campaign group identifier can be expressed as a string “<CampaignGroup DBID>” This ID is attached to every outbound contact initiated on behalf of that campaign. An agent that has more than one campaign assignment can only serve one campaign at a time but may be dynamically switched back and forth between campaigns as needed.

In one embodiment OCS 102 expresses a current campaign group ID for an agent place object using a Java format through a Java extension adapted provided to the stat server.
Category=Java Category
Java SubCategory=OCCStatExtension.Jar: CurrentCampaignGroupDBID
Objects=Agent,Place

The values possible are 0 meaning the agent is not currently assigned to any campaign group and the DBID of a Campaign Group config Object. In one embodiment, every outbound contact includes a special attached data attribute.
Key=GSW_CAMPAIGN_GROUP_DBID Type=String Value=“<Campaign Group DBID>”
Key=GSW_CAMPAIGN_GROUP_NAME Type=String Value=‘<Campaign Group Name>”

In one embodiment where call progress detection (known to the inventor) is used, a CTI-server, i.e. T-Server, may be provided and configured to inherit attached data for call consulting. In an active switching matrix (ASM) mode, each campaign group may be assigned a unique voice transfer destination number (DN) in a case where no contact data is attached to the outbound contacts. In that case URS 103 may assign all answered contacts to a particular routing point assigned to a particular campaign group.

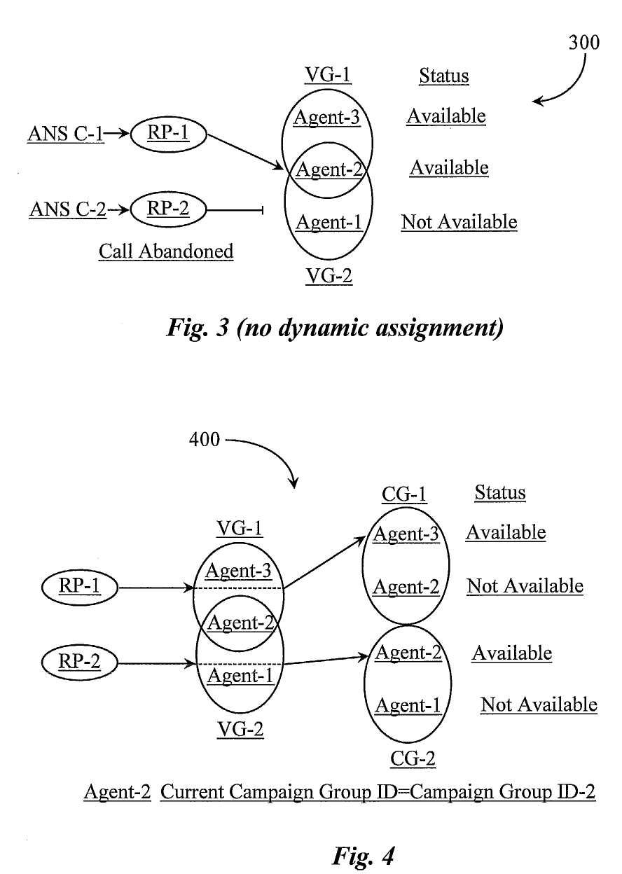

FIG. 3 is a block diagram 300 illustrating contact abandonment resulting from no dynamic assignment capability. In this simple contact distribution example there are two answered contacts resulting from two outbound contact campaigns running concurrently. These are ANS C-1, and ANS C-2. It may be assumed that ANS C-1 is for campaign 1 and ANS C-2 is for campaign 2. ANS C-1 is forwarded to routing point 1 (RP-1) for distribution while ANS C-2 is forwarded to RP2 for distribution.

In this example without the benefit of the present invention, there are two virtual agent groups, VG-1 and VG-2. VG-1 is the routing target of RP-1 and VG-2 is the routing target of RP-2. It is noted that agent-2 is assigned to serve in either group. In the instant scenario, Agent-3 and Agent-2 were deemed available and Agent-3 was deemed not available or not ready. Without benefit of the invention Agent-2 is considered ready in both VGs. This means that RP-1 may route ANS C-1 to Agent 2 with a 50% probability. Assuming RP-1 routes to Agent-2, RP-2 now has no available agent to connect with leading to possible contact abandonment.

FIG. 4 is a block diagram 400 illustrating contact completion based on an ability to dynamically re-assign an available agent, as in embodiments of the present invention. In this example, in addition to VG assignment, each agent is also assigned to a unique campaign group (CG). Also in this example the agents have the same VG assignments as described above with Agent-2 assigned to both VGs. Agent-3 and Agent-2 each belong to CG-1 while Agent-2 and Agent-3 each belong to CG-2. Therefore, Agent-2 may serve either CG. In principal, Agent-2 may work only one campaign group at a time. Actual assignment of CGIDs to agents may be a matter of association to the agent VG assignment since the VGs are assigned as targets for the campaigns. OCS 102 designates Agent-2 available or ready only for CG-2, target of RP-2 for distribution of a contact for campaign 2. Agent-2 is designated not ready or not available to serve contacts of CG-1. “<CurrentCampaignGroupDBID>”=2 is the statistical value for Agent-2 at the time of contact initiation. Therefore RP-1routes its contact (ANS C-1) to Agent-3, which is the only available agent in VG-1. RP-2 routes its contact (ANS C-2) to Agent-2, the only available agent in VG-2. In this example, each RP has an available agent for its contact.

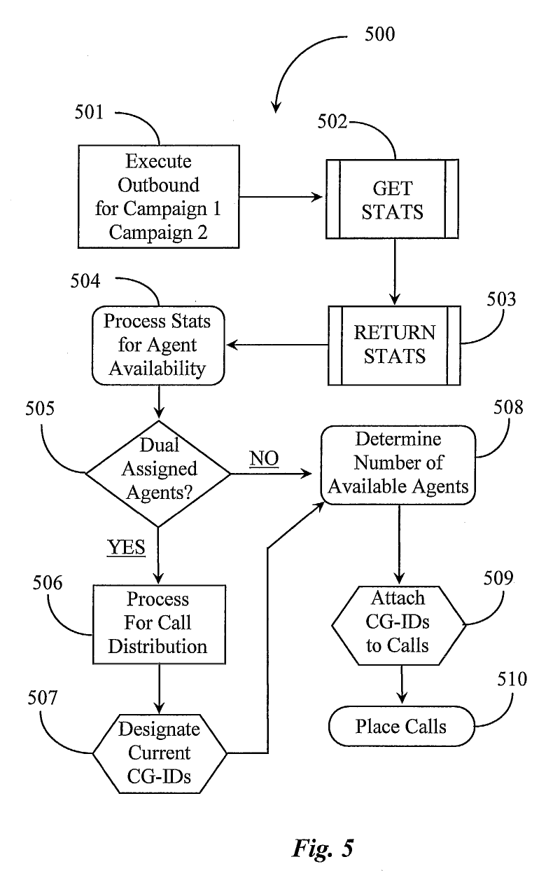

FIG. 5 is a process flow chart 500 illustrating steps for determining contact initiation numbers during execution more than one outbound campaign according to an embodiment of the invention. At step 501, outbound contact campaigns are executed for a campaign 1 and a campaign 2. This is performed by an outbound contact server such as OCS 102. There may be more than two outbound campaigns running concurrently, but two campaigns illustrated serves to explain the invention.

At step 502, the OCS gets information. OCS may subscribe to a stat server to receive information periodically, or it may get such upon request. The information requested comprises the states of activity of the agents assigned to VGs and CGs for use in determining how many contacts to initiate for the concurrent outbound campaigns. At step 503, the stat server returns the information to the OCS. It is noted herein that only updated statistics affecting agent place/objects may be propagated.

At step 504, OCS processes the statistics for agent availability. At step 505, the OCS determines if there are agents assigned to both campaigns. If in step 505 there is at least one available agent dually assigned, at step 506 those stats are processed according to contact distribution rules. OCS must determine which CG-ID any agents having more than one assignment will serve. This may be accomplished according to a variety of rules depending on the situation. One simple example is to make a determination based on contact distribution principles.

At step 507, the OCS designates current CG-IDs to those agents that have more than one assignment. After this designation they may be counted ready for a single CG-ID number. At step 508, the OCS determines the number of available agents for each campaign group. In one embodiment, that number determined will equal the number of contacts that will be initiated for each campaign.

At step 509, the OCS attaches the CG-IDs as contact data to each contact and in step 510 the outbound contacts are initiated. If at step 505 there are no agents having more than a single assignment, the process skips to step 508 and proceeds from step 508 to step 510.

The values that can be retrieved include but are not limited to Current Agent Assignment, CurrentNumberAgentsAssigned, and CurrentCampaignGroupDBID.

For CurrentAgentAssignment, the possible values include ‘Inbound’ meaning the agent is not currently assigned to an outbound campaign and CampaignGroupName, which is the name of a CampaignGroup config Object. An agent may have more than one assignment here.

CurrentCampaignGroupDBID has a value that defines the current campaign group that the agent is assigned or designated to and may be a number. A 0 is a possible value meaning that the agent is not currently designated for outbound processing. A value=to CampaignGroupDBID=the DBID of CampaignGroup config Object. The metric for number of assigned agents is

[CurrentNumberAgentsAssigned]

Category=JavaCategory

JavaSubCategory=OCCStatExtensionjar: CurrentNumberAgentsAssigned

Objects=CampaignGroup

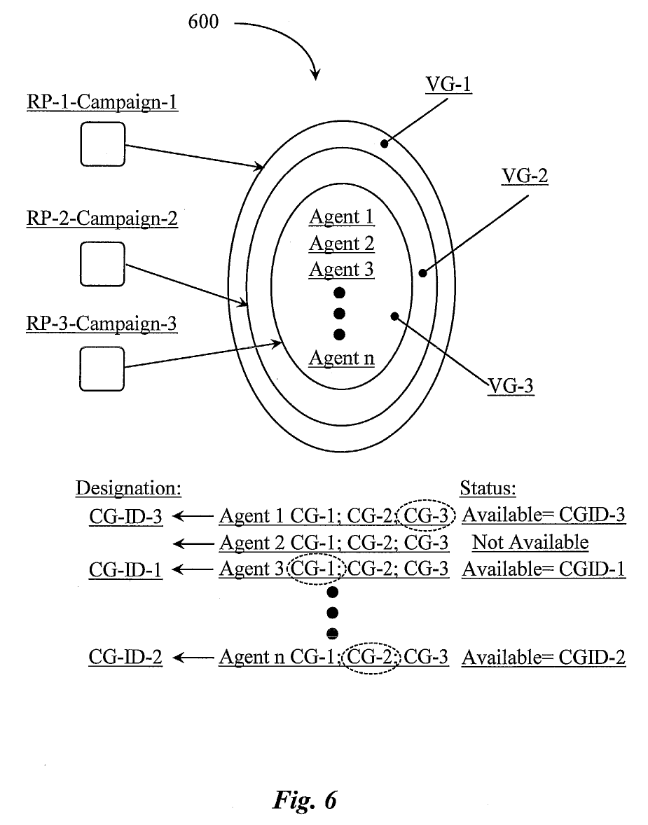

FIG. 6 is a block diagram 600 illustrating contact completion based on universal agent assignment selection according to another embodiment of the present invention. Diagram 600 illustrates three concurrent outbound campaigns running in an OCS. Each of the campaigns has a designated routing point RP-1 (Campaign-1), RP-2 (Campaign-2), and RP-3 (Campaign-3). There are three virtual agent groups (VGs), VG-1, VG-2, and VG-3.

RP-1 has as a target, VG-1. RP-2 has as a target VG-2, and RP-3 has as a target VG-3. In this example, there are agents Agent-1 through Agent-n. In this embodiment, all of the agents are qualified to work all of the contact campaigns, and are so assigned. Therefore, each VG includes agents assigned to the other two VGs as well. In this regard, a VG priority may appear to the agent via screen pop or other notification when logging in to indicate which VG the agent has a priority to begin serving in.

As in the previous examples, each VG is assigned to a specific outbound campaign or campaign group (CG). As in the previous example, an agent may only serve a single campaign group at one time. The overriding principle for this embodiment is a contact distribution load balancing principle to keep each of the campaigns running smoothly by allocating available agent resources evenly among the routing points by dynamically designating to agents CurrentCampaignGroup DBIDs as needed to even out available agents among the campaigns therefore placing a number of contacts at each interval for each campaign.

In the embodiments described, agents receive advanced notification of the campaign they are serving ahead of the contact for that campaign. In some cases the agents may be pulling contacts from a VG queue. In this example, Agent-2 is not available. Agent-1 is designated for CG-3 and has a status available value CampaignGroupDBID=3 (CGID-3). Agent-3 is designated for CG-1 and Agent-n is designated for CG-2 and corresponding CG DBIDs are associated with those agents. OCS initiates one contact for each campaign group based on agent availability designation. For example, the original assignments may have resulted in all of the available agents designated for a single CG. In order to ensure contacts were initiated for the other campaigns wherein the contacts would be answered, OCS designated current IDs to the pool of available agents to ensure their participation. Hence RP-1, RP-2, and RP-3 each had an available agent waiting for the contact.

In this embodiment, the agents are qualified to work any of the campaigns and so are assigned for all of them. However, during contact initiation they will only be designated to a single campaign at a time. This dynamic designation technique helps ensure that no one of the three campaigns is starved of available agents. As one campaign ends with the other two still running, all agents drop the ended campaign ID from their assignments, but may keep their VG assignments. More resources become available for the remaining campaigns should they be needed. VGs may be dynamically loaded for planned outbound contact campaigns and dynamically reshaped during the course of those campaigns to better serve customers. Agent notification ahead of contact routing serves to alert the agent to what campaign the next contact is connected to. Scripts and other prompts related to the pending contact may also be provided with the alert.

In one embodiment agents associated in a virtual agent group each have a reportable group identifier. Each virtual agent group has a reportable campaign group identifier that may also be a reportable attribute of agents in those groups. It is noted herein that campaign group DBIDs are only temporary because they are unique to active outbound campaigns. Time to Live (TTL) for a campaign group DBID may be limited to the life of the campaign while VAG identifiers may be configured objects. In one case where VAGs are associated one on one to a unique campaign identifier, by association the agents in those groups are also identifiable by the campaign identifier.

It will be apparent to one with skill in the art that the agent resource assignment system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A system for outbound contact campaigns, comprising:
a contact server for initiating outbound contacts each associated with one of a plurality of outbound campaigns; and
a statistical server for monitoring and serving current statistics pertaining to the operation of the campaigns;
characterized in that the contact server initiates outbound contacts for the campaigns based on availability of agents assigned to the campaigns, and wherein agents available for assignment to more than one campaign are dynamically assigned to serve a specific one of the campaigns based on the statistics.

2. A contact server for placing outbound contacts, comprising:
an automated dialer;
an interface to a stat server;
a processer for processing statistics; and
a data port connected to a router;
characterized in that the contact server receives from the stat server information regarding agent availability and agent campaign assignment, processes the information against one or more rules, associates each available agent with one and only one campaign at the time of contact initiation, and attaches an agent group identifier as data to each outbound contact, the identifier serving to route answered contacts to available agents.

3. A method for conducting an outbound telephone campaign, comprising the steps of:
(a) determining agent availability at the time of contact initiation;
(b) considering each available agent as assigned to one and only one campaign at the time of contact initiation, regardless of pre-assignment;
(c) appending a campaign group identifier to each outbound contact; and
(d) using the identifier from step (c) to route answered contacts to available agents.
